(19) United States
(12) Patent Application Publication
(10) Pub. No.: US 2025/0128673 A1
(43) Pub. Date: Apr. 24, 2025

(54) DRIVER PROTECTION SYSTEM ENCLOSURE STYLE DOOR

(71) Applicant: AROW GLOBAL CORP., Mosinee, WI (US)

(72) Inventor: Christopher Michael MORRIS, Wausau, WI (US)

(21) Appl. No.: 18/918,806

(22) Filed: Oct. 17, 2024

Related U.S. Application Data
(60) Provisional application No. 63/680,699, filed on Aug. 8, 2024.
(60) Provisional application No. 63/544,864, filed on Oct. 19, 2023.

(51) Int. Cl. B60R 21/12; B62D 33/06

(52) U.S. Cl. CPC B60R 21/12; E05B 77/22; E05B 85/247; B60Y 2200/143

(57) ABSTRACT

A novel door and partition assembly for transit vehicles is provided. The door extends from the floor to the ceiling of the transit vehicle and the partition extends from the floor to the ceiling of the transit vehicle and to the windshield and dashboard area such that passengers cannot reach around the door and partition assembly into the operator's area. A novel locking mechanism is provided having an external and internal release mechanism which allows the operator to enter and exit the operator's area of a transit vehicle having the novel door and partition assembly.

### CROSS-REFERENCE TO RELATED APPLICATIONS

This application claims the benefit and U.S. Patent No. 63/680,699 filed Aug. 8, 2024 and U.S. Patent Application No. 63/544,864 filed Oct. 19, 2023. The entire disclosures of the above applications are incorporated herein by reference.

### FIELD OF THE INVENTION

The present invention relates to a novel partition and locking mechanism for public transit vehicles.

### BACKGROUND OF THE INVENTION

Door and partition assemblies are often used in transport vehicles, e.g. buses and streetcars. These assemblies function to provide the operator of the transport vehicle an enclosed area which is separate from passenger areas.

Such door and partition assemblies are designed to allow the operator to operate the transport vehicle in an uninhibited and safe manner while at the same time providing personal safety from potentially violent passengers.

Existing door and partition assemblies have a sizeable gap from the top of the door up to the ceiling and at the dash area near the windshield. This design, however, is not a simple oversight. The gaps allow the driver to gain access to the operator's area from the outside by reaching around the partition and accessing a handle to unlock the door.

A negative repercussion of such a design is that these gaps also allow passenger's access to the operator's area, which may interfere with the safe operation of the vehicle or cause harm to the operator.

To circumvent this potential safety issue, a novel door and partition assembly has been developed which does not have gaps between the ceiling, windshield and dashboard. A novel lockout mechanism has also been developed which enables the driver to gain access to the operator's area from the outside without the need to reach around the partition.

### SUMMARY OF THE INVENTION

A brief description of the invention is provided.

The invention relates to a partition and door assembly for the operator's area of transit vehicles.

The partition has a window that extends upwards to the ceiling of the operator's area in the transit vehicle and further extends to the windshield and dashboard of the transit vehicle, such that the window cannot be reached over or around.

The window of the partition is secured to a mounting bracket which extends from the floor of the transit vehicle and frontwards around the dashboard, and if present, the farebox. The mounting bracket also has a latch loop, which is used to lock the door.

The window of the partition is secured to the ceiling of the driver's area by a top hinge and to the mounting bracket by a bottom hinge, which allows the bottom of the partition window to move inwardly when the farebox needs servicing.

The bottom hinge of the partition window is secured to the window through an isolator mount, which absorbs shock as the chassis flexes while travelling over rough roads, preventing the partition window from shattering.

The door has a window which extends to the ceiling of the operator's area and is adjacent to the window of the partition.

The bottom edge of the door window is secured to a panel which forms the lower part of the door.

A bottom door panel attaches to the window on its bottom edge and forms the bottom half of the door.

The door is pivotally attached to a frame at the rear of the operator's area, such that the door can be moved between open and closed positions.

The door has a lock housing which is generally aligned with the latch loop of the mounting bracket of the partition and contains a locking mechanism.

The lock housing has a recess on the inner side for receiving the latch loop. A latch mechanism extends across the opening of the recess and is moveable between an open configuration where the latch loop may enter or leave the recess and a closed mechanism where the latch loop is trapped in the recess.

A latch lever is pivotally mounted to the lock housing, a proximal end of which is U-shaped and sized to fit the latch loop.

A distal end of the latch lever is attached to a column, such that when force is applied to the column in the medial or inner direction, the latch lever pivots, in turn moving the proximal U-shaped end opposite a medial direction or outer direction.

When the proximal U-shaped end is opposite the medial direction, the latch loop can freely move in or out of the proximal U-shaped arm. When the latch loop is in the proximal U-shaped end in the medial position, the latch loop is prevented from being released.

The lock mechanism contains both an external and an internal release mechanism.

The internal release mechanism has a second internal release lever which is pivotally mounted to the lock housing and located distal to the latch lever. A proximal arm of the second internal latch lever extends to the column of the latch lever.

When the proximal arm of the second internal release lever is moved in the medial direction the proximal arm applies force to the column of the latch lever moving it in the medial direction, resulting the proximal U-shape end of the latch lever moving opposite the medial direction and into the open position.

A biasing mechanism acts between a distal arm of the second internal release lever and the lock housing, such that the distal arm of the second internal release lever is maintained in the medial position unless force is applied to the distal arm opposite the medial direction.

The internal release mechanism has a first internal release lever pivotally mounted to the lock housing and located distal to the second internal release lever. An actuator rod is attached to the proximal end of the first internal release and extends to the distal arm of the second internal release lever.

A handle is attached to a distal arm of the first internal release lever to which force can be applied manually by the driver. When force is applied to the handle in the in the medial direction, the first internal lever moves opposite the medial direction, wherein the column on the proximal arm of the first internal release lever moves medially and applied force to the distal arm of the second internal release lever.

The external release mechanism has an external release lever pivotally mounted to the lock housing distal to the latch lever. A proximal arm of the external release lever extends to the column of the latch lever such that when the proximal arm of the external release lever moves in the medial direction, force is applied to the column on the distal arm of the latch lever in the medial direction.

The external release lever has a handgrip positioned between the proximal arm and a distal axis. When force is applied to the handgrip in the medial direction, the proximal arm moves in the medial direction.

The external release lever has a distal arm position on the distal side of the distal axis.

A lockout is secured to the lock housing located distal to the external release lever. The lockout has a rotatable external portion which is accessible on the outside of the door and a rotatable internal portion located on the inside of the door.

A rotatable tab is connected to the internal portion, such that the rotatable tab extends to the distal arm of the external release lever preventing the distal arm of the external release lever from pivoting opposite to the medial direction unless rotated.

### BRIEF DESCRIPTION OF THE DRAWINGS

These and other features of the invention will become more apparent from the following description in which reference is made to the appended drawings wherein:

FIG. 1 is a perspective view of the external of a door and partition assembly.

FIG. 2 is a perspective view of the internal of a door and partition assembly.

FIG. 3 is a perspective view of the external of an installed door and partition assembly.

FIG. 4 is a side view of the external of a door and partition assembly.

FIG. 5 is a side view of the internal of a door and partition assembly.

FIG. 6 is a perspective view of the external of a partition.

FIG. 7 is a perspective view of the internal of a partition.

FIG. 8 is a perspective view of the external of a partition fitted for a fare box.

FIG. 9 is a perspective view of the internal of a partition fitted for a fare box.

FIG. 10 is a perspective view of the internal of the lock housing.

FIG. 11 is a perspective view of the external of the lock housing.

FIG. 12 is a side view of the internal of the lock housing.

FIG. 13 is a side view of the external of the lock housing.

FIG. 14 is an exploded view of the lock housing.

FIG. 15 is an exploded view of the latch and recess mechanism.

FIG. 16 is a perspective view of the lock housing installed with latch loop unsecured.

FIG. 17 is a perspective view of the lock housing with latch loop secured.

FIG. 18 is a perspective view of the lock mechanism in a closed position.

FIG. 19 is a perspective view of the lock mechanism in a closed position.

FIG. 20 is a birds eye view of the lock mechanism in a closed position.

FIG. 21 is a perspective view of the lock mechanism in an open position.

FIG. 22 is a perspective view of the lock mechanism in an open position.

FIG. 23 is a birds eye view of the lock mechanism in an open position.

FIG. 24a is an exterior side view of the partition with top and bottom hinges closed.

FIG. 24b is a side view of the partition with the top and bottom hinges closed.

FIG. 25a is an exterior side view of the partition with top and bottom hinges open.

FIG. 25b is a side view of the partition with top and bottom hinges.

FIG. 26a is an interior side view of the partition with top and bottom hinges closed.

FIG. 26b is side view of the partition with top and bottom hinges closed.

FIG. 27a is an interior side view of the partition with top and bottom hinges open.

FIG. 27b is a side view of the partition with top and bottom hinges open.

FIG. 28 is a perspective view of the top partition hinge in closed position.

FIG. 29 is a side view of the top partition hinge in closed position.

FIG. 30 is a perspective view of the top partition hinge in open position.

FIG. 31 is a side view of the top partition hinge in open position.

FIG. 32 is an exploded view of the top partition hinge.

FIG. 33 is a perspective view of the bottom partition hinge and isolator mount in open position.

FIG. 34 is a perspective view of the bottom partition hinge and isolator mount in closed position.

FIG. 35 is a side view of the bottom partition hinge and isolator mount in open position.

FIG. 36 is a side view of the bottom partition hinge and isolator mount in closed position.

FIG. 37 is an exploded view of the isolator mount.

### DETAILED DESCRIPTION OF THE INVENTION

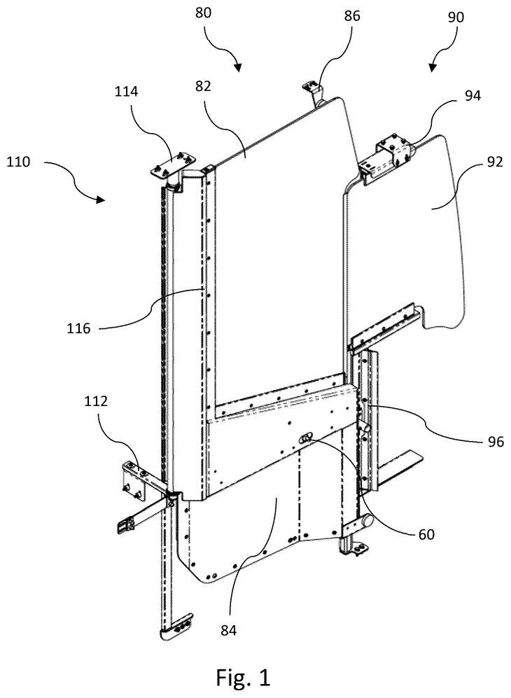

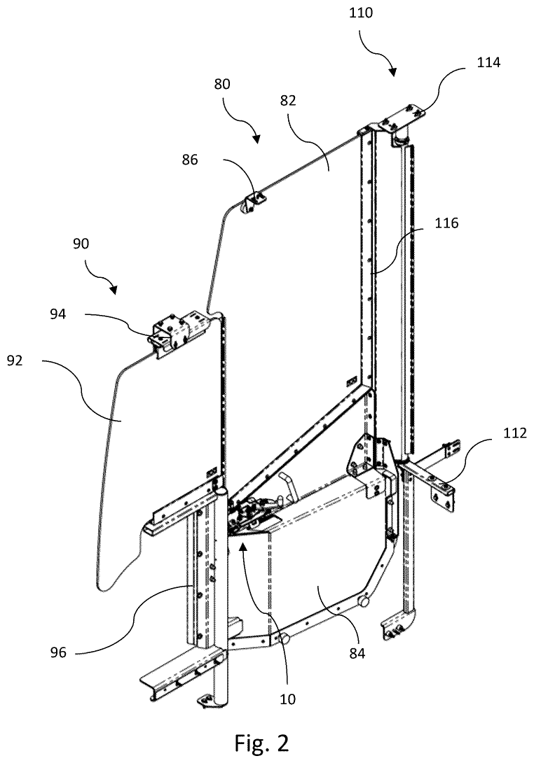

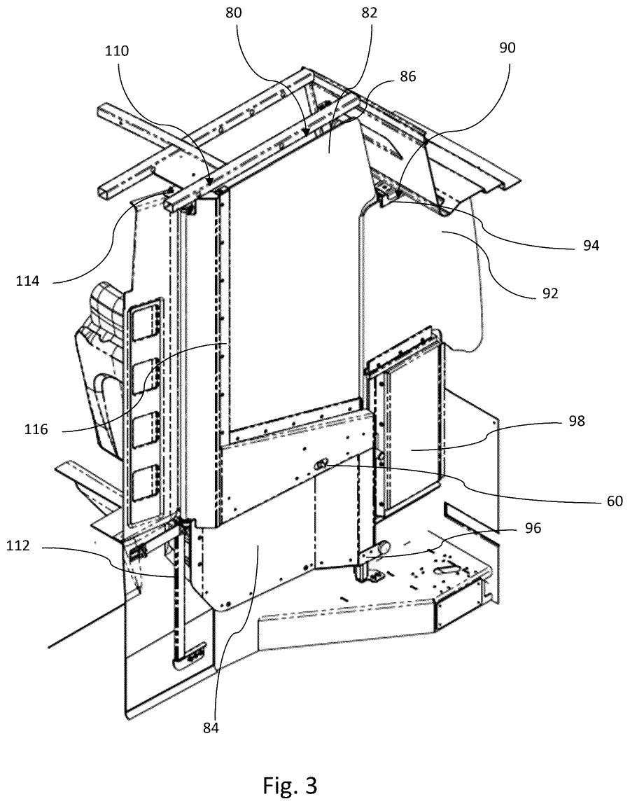

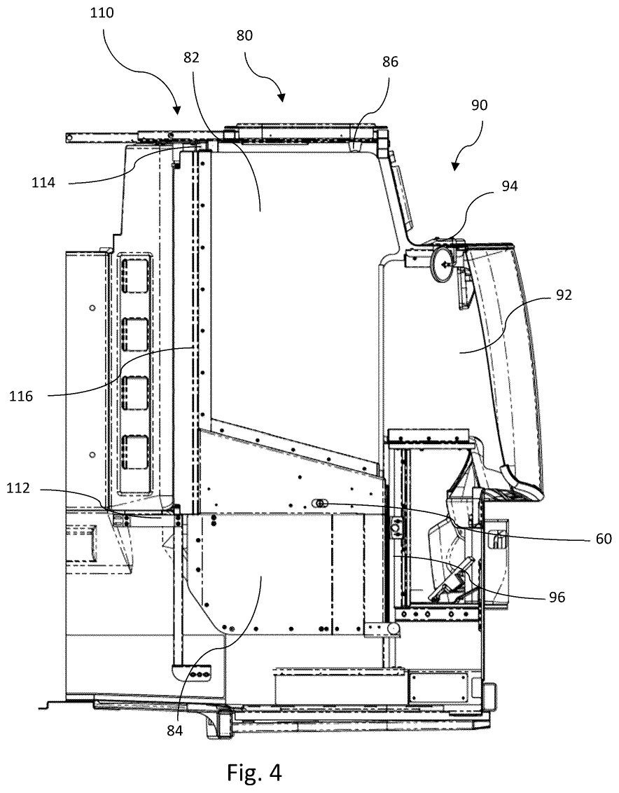

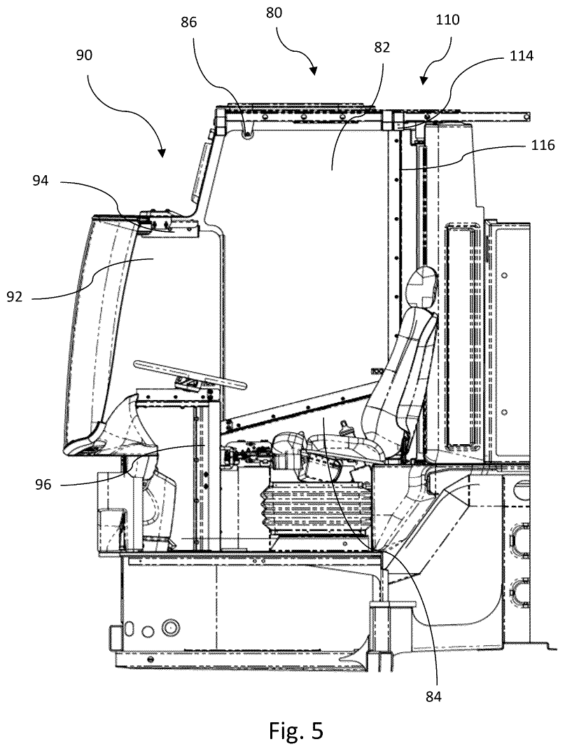

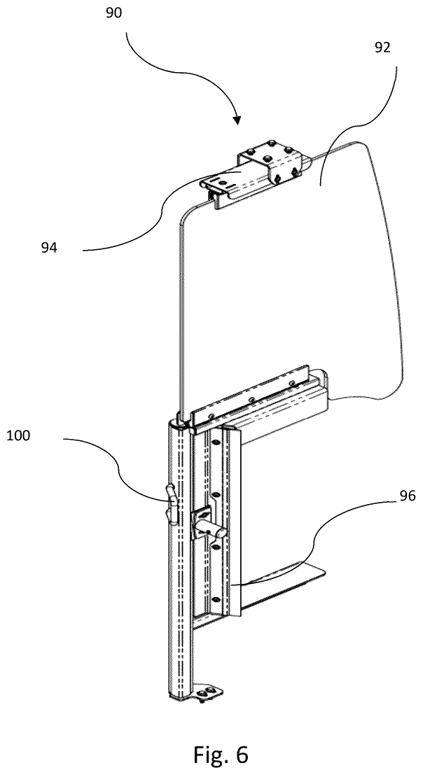

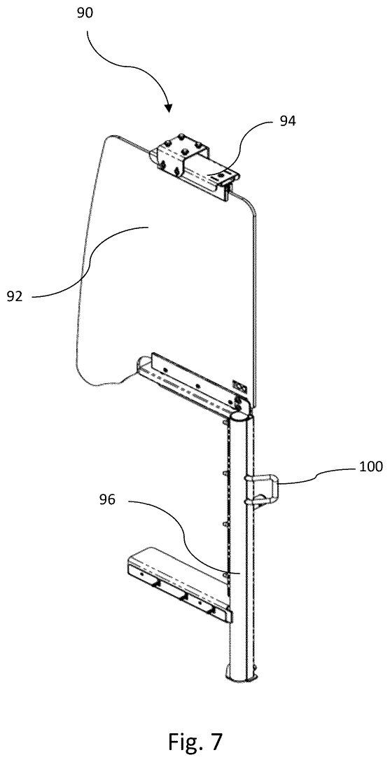

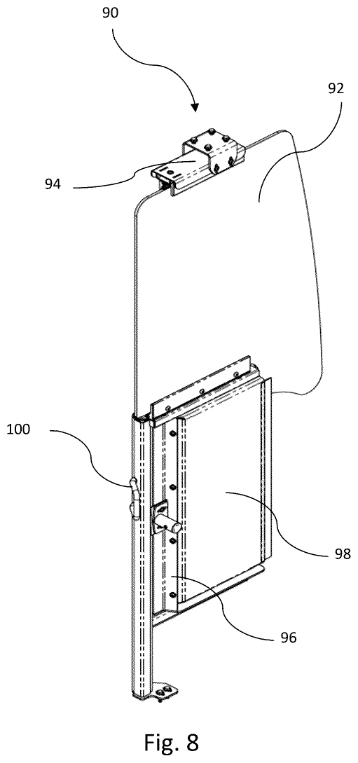

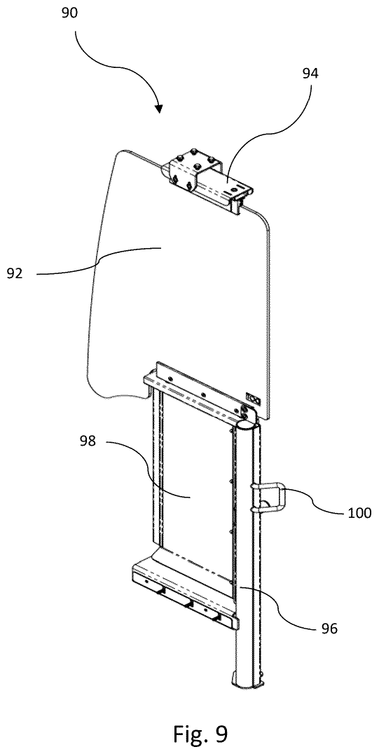

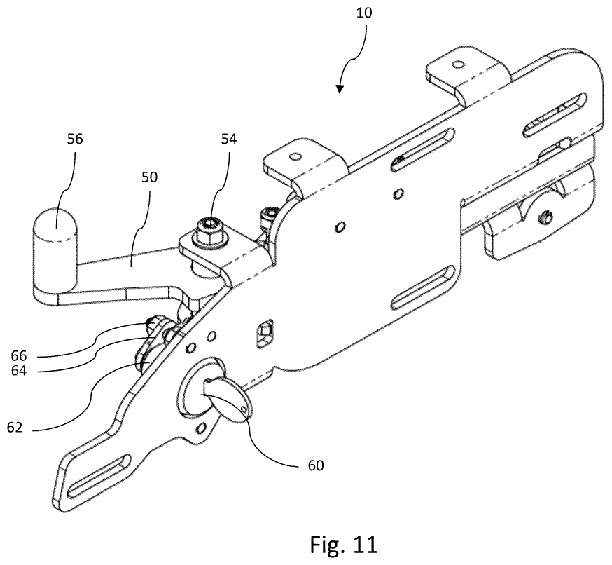

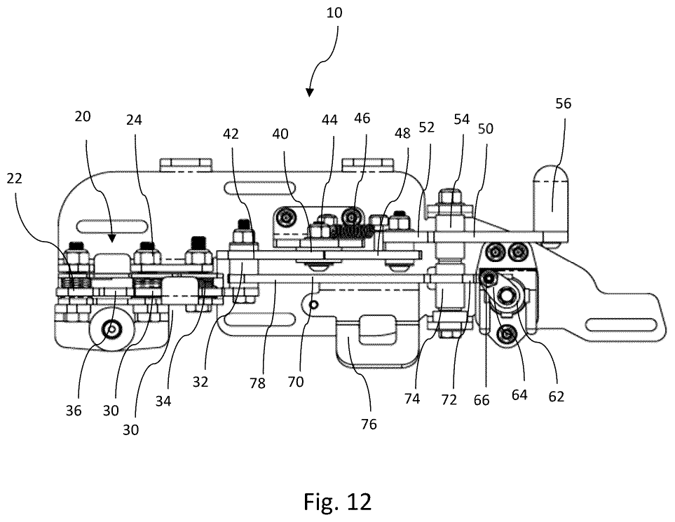

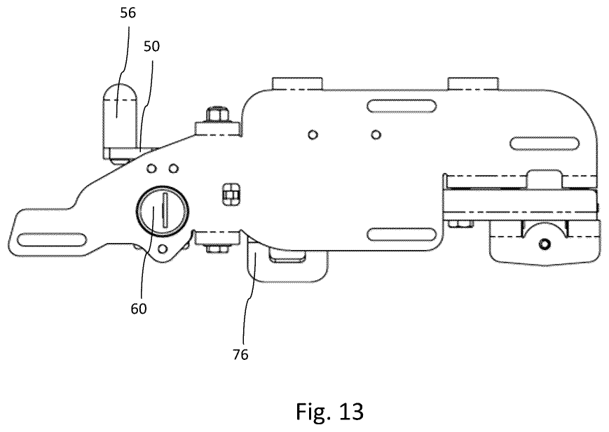

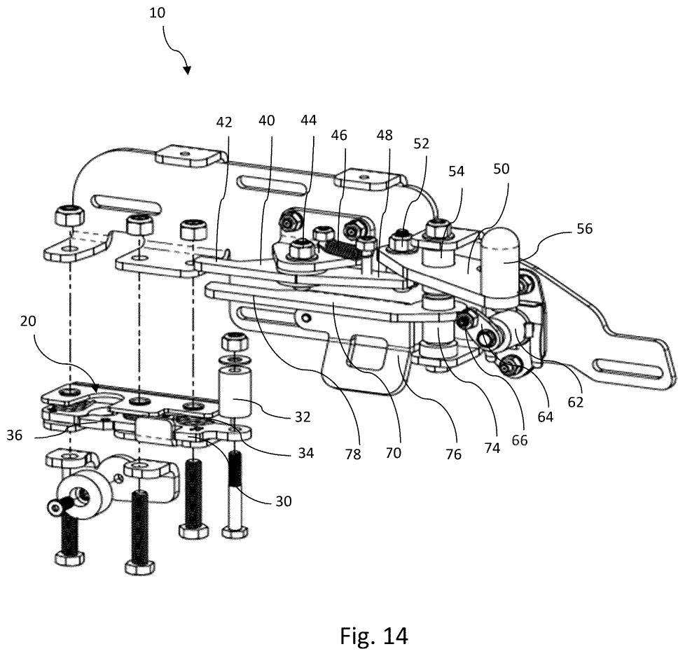

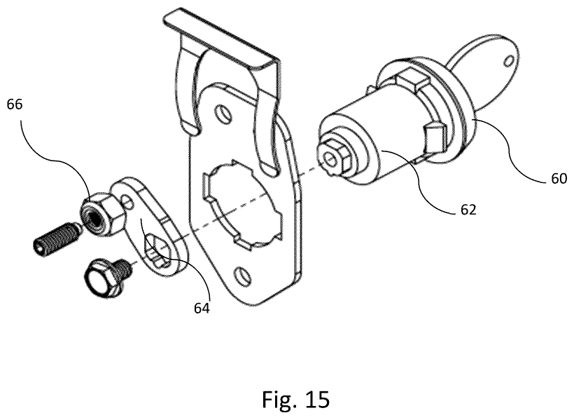

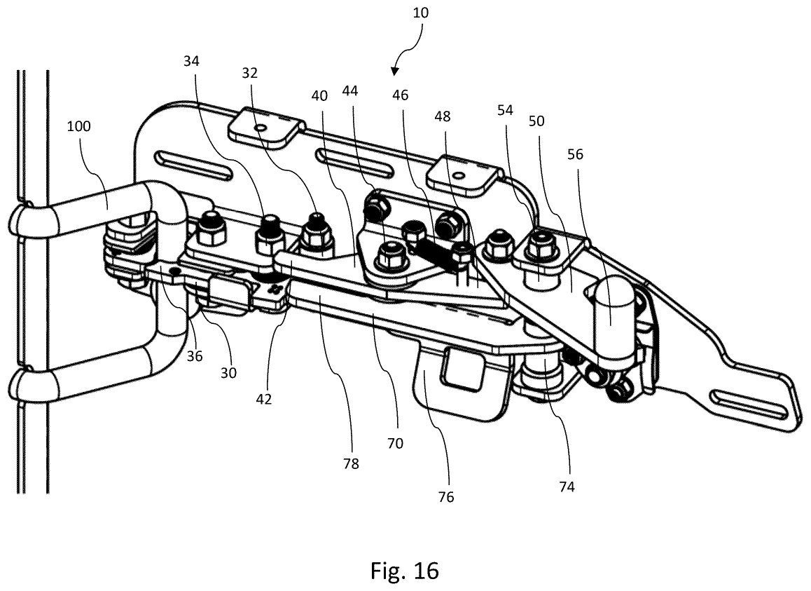

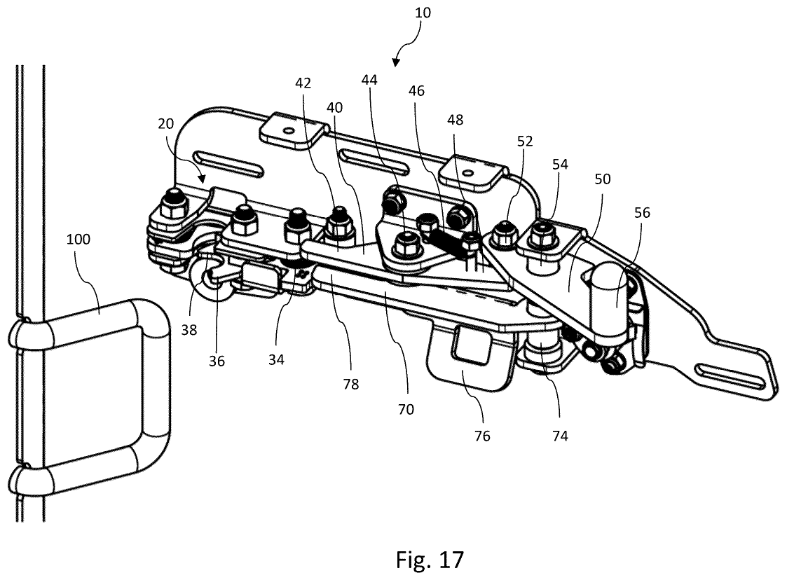

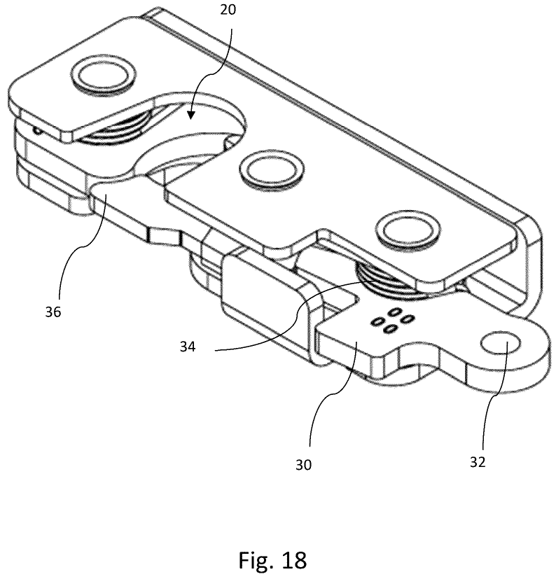

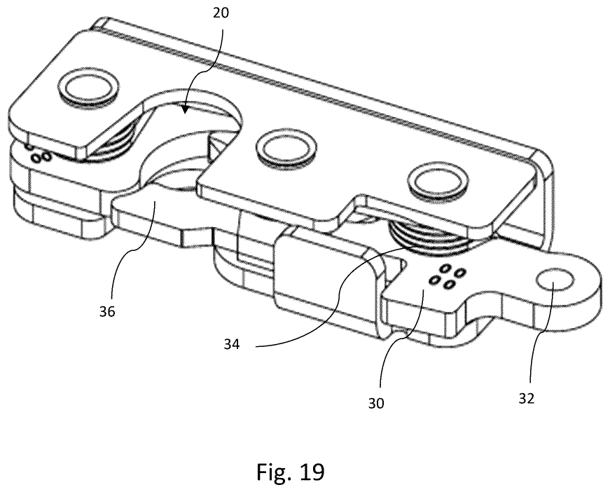

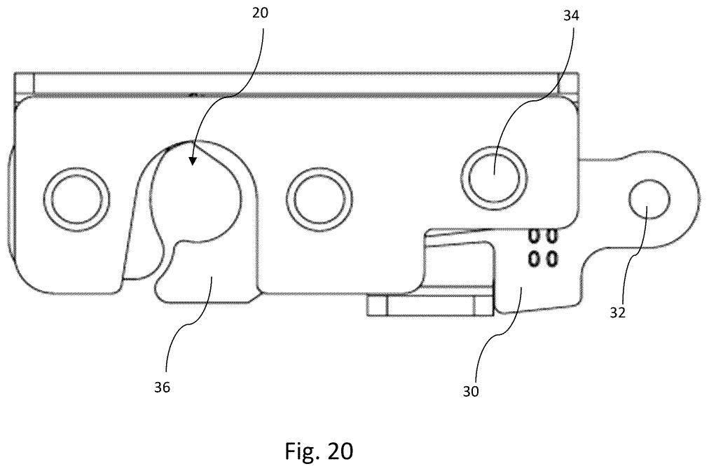

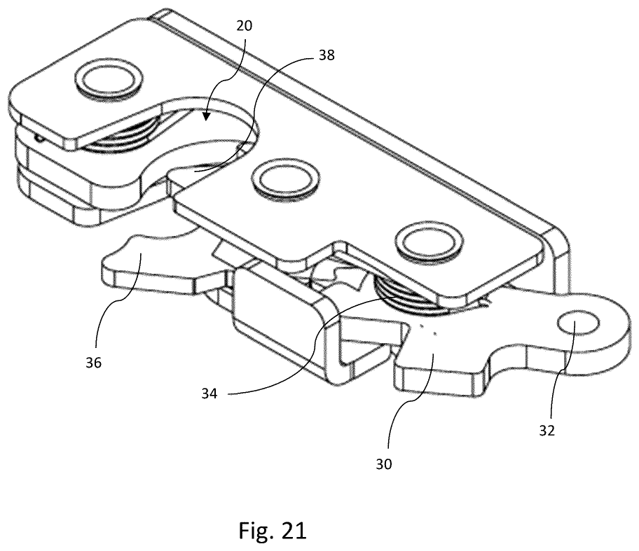

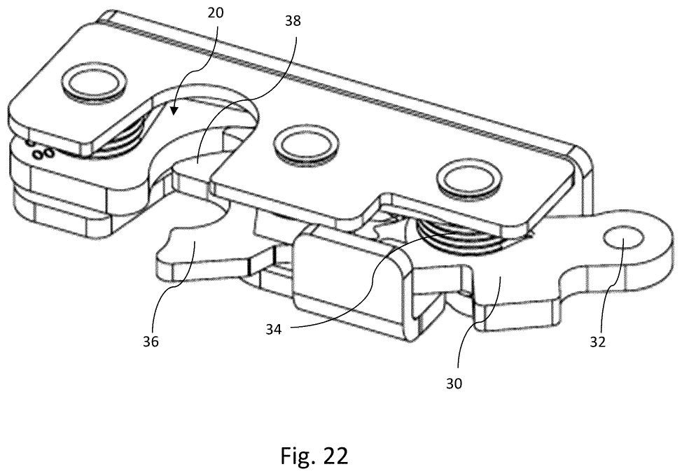

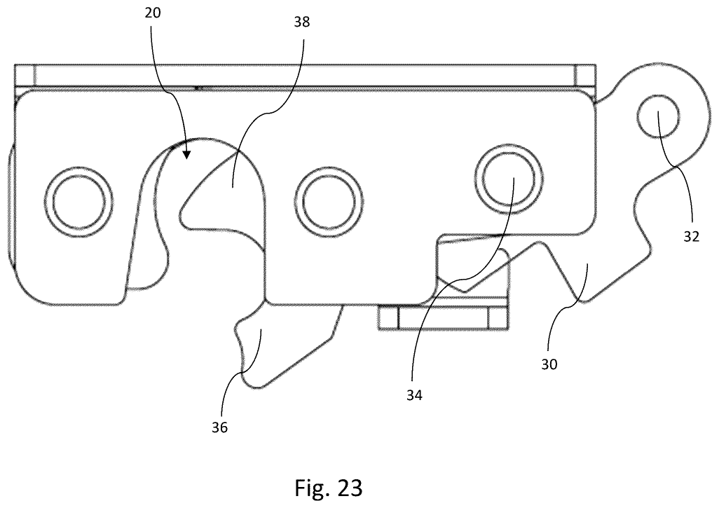

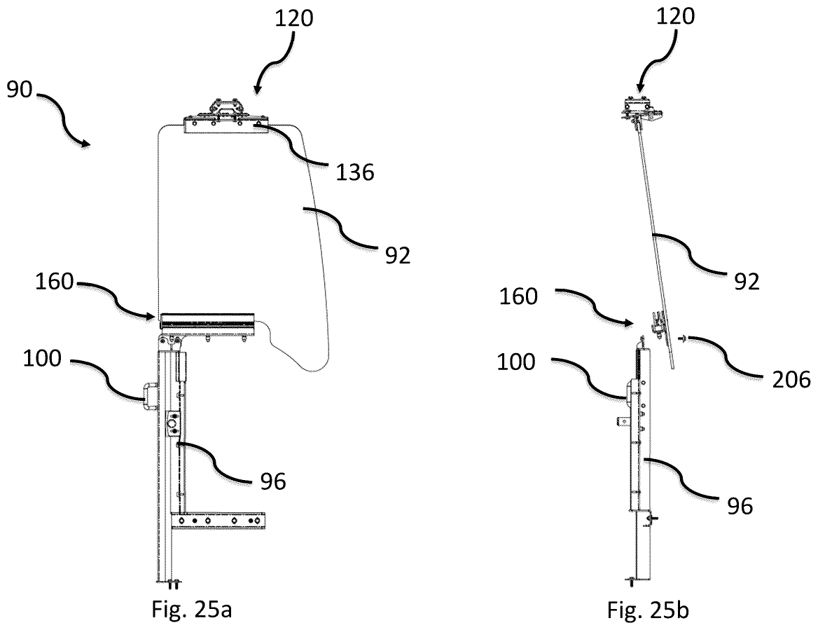

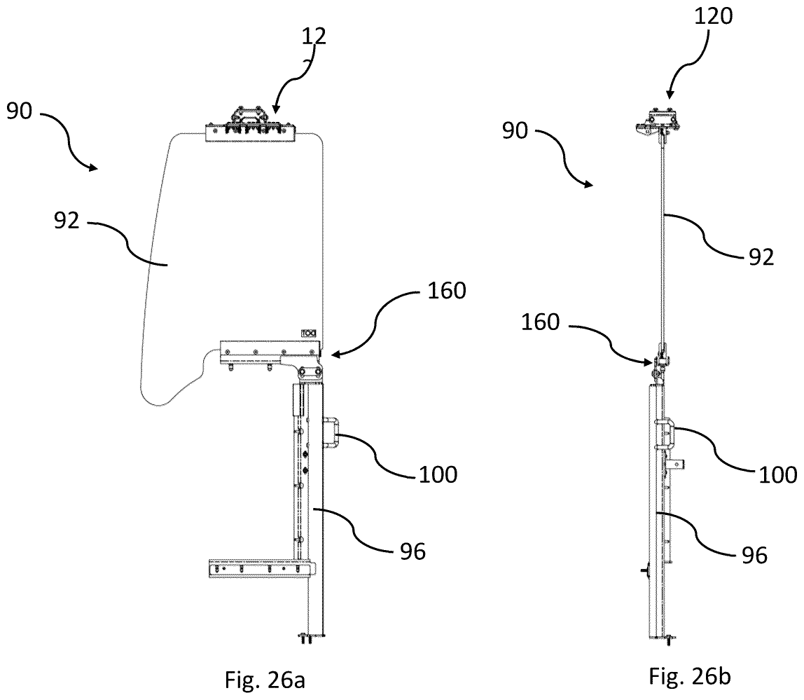

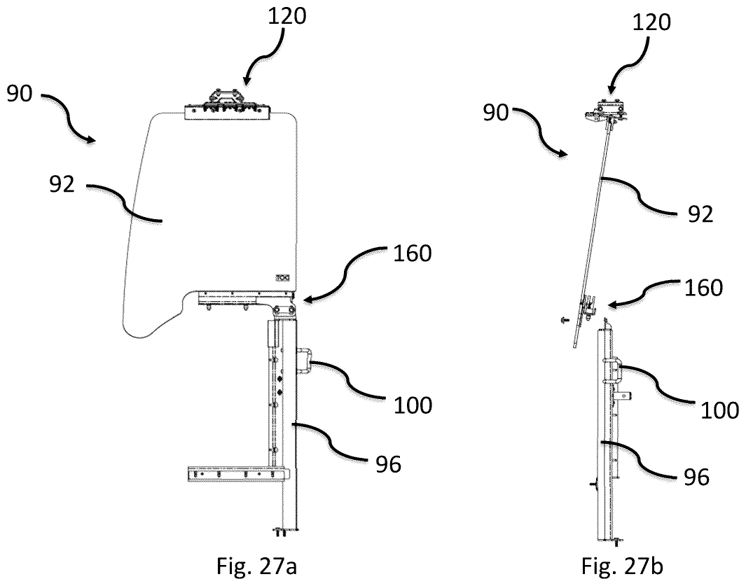

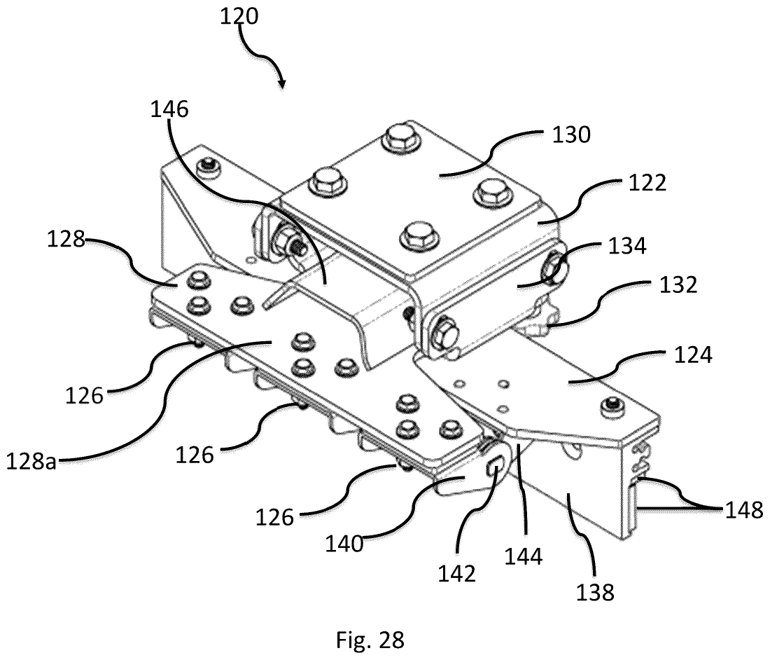

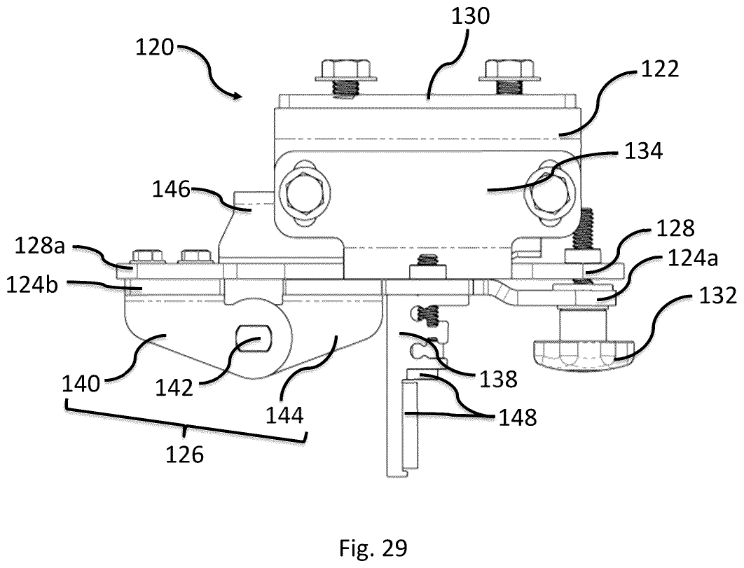

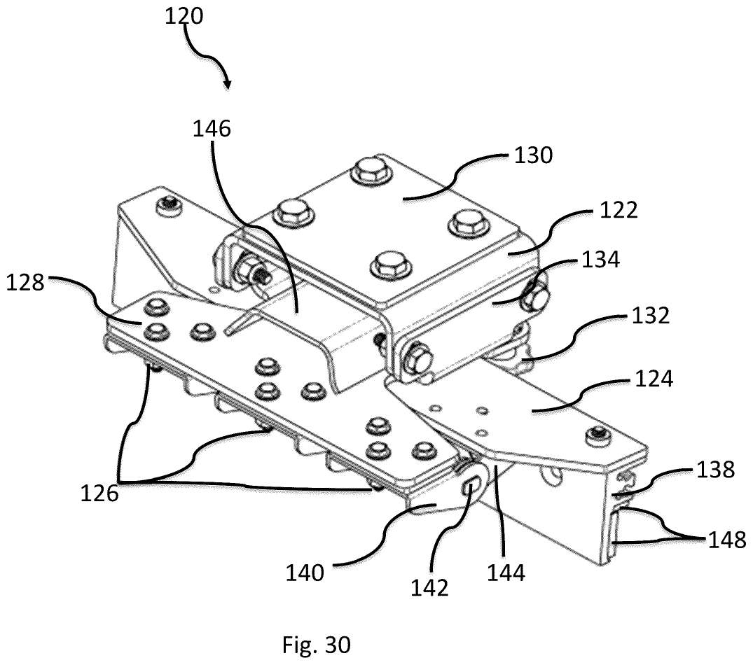

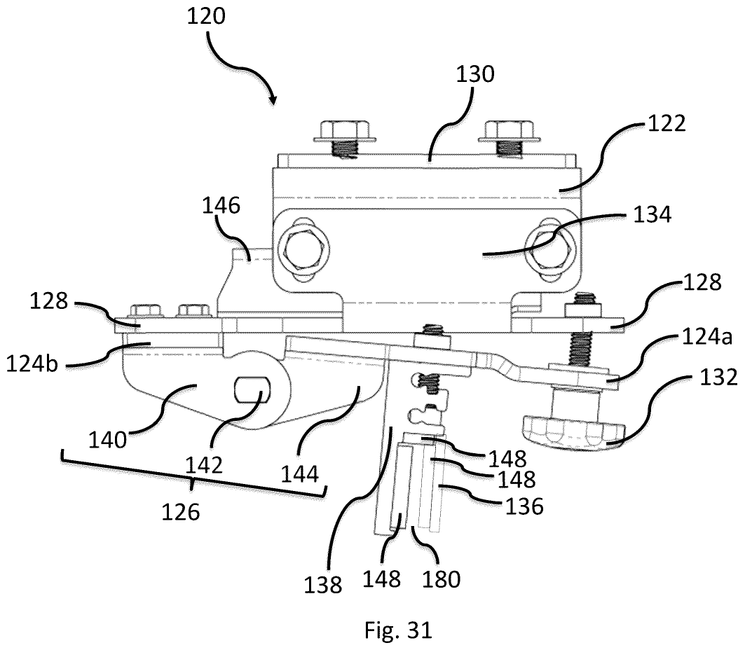

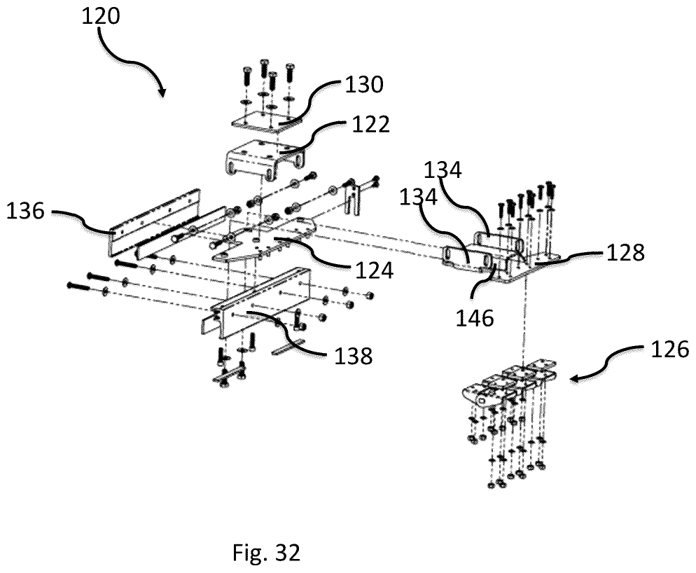

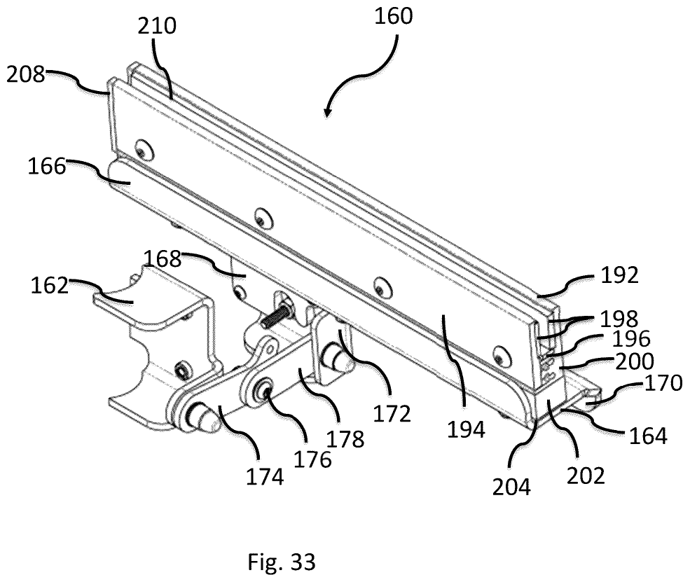

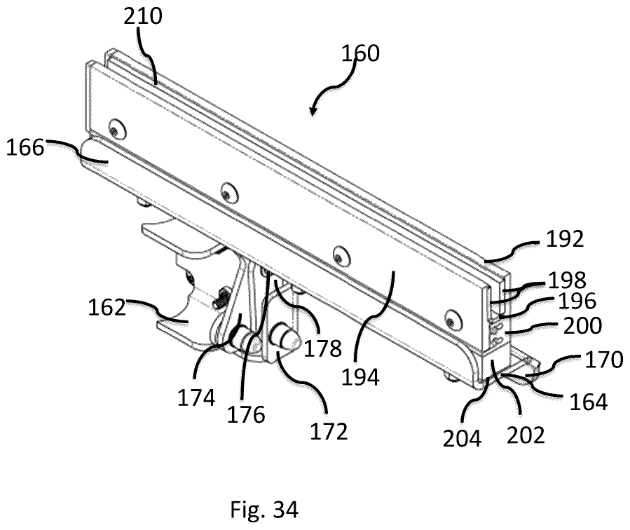

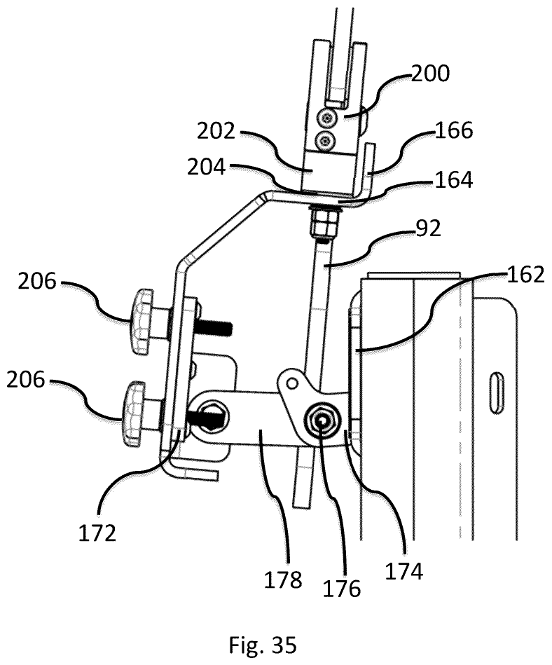

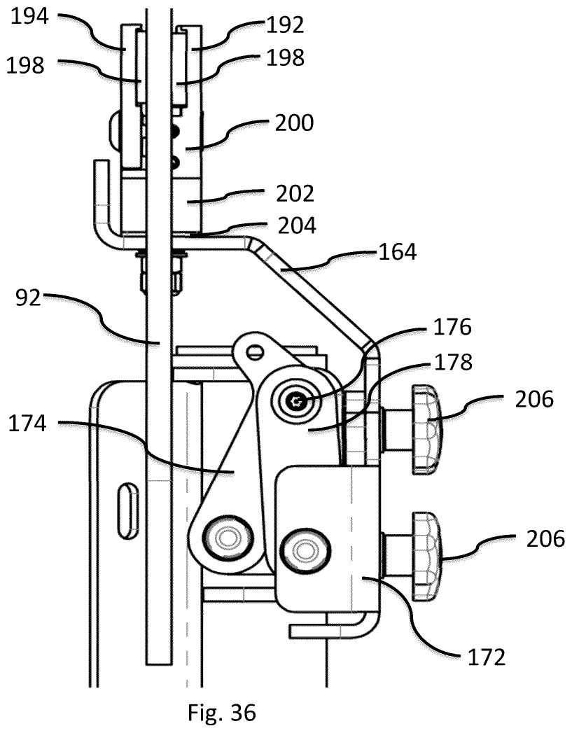

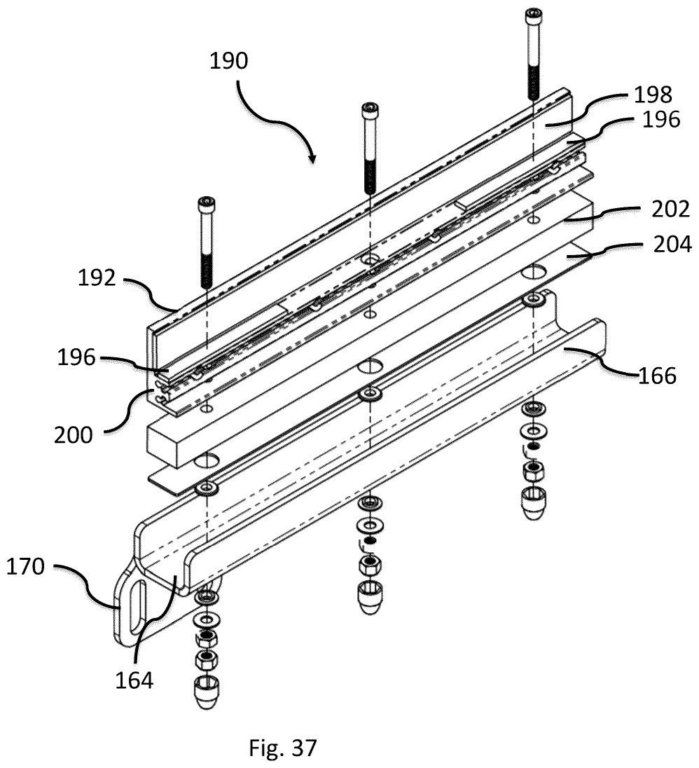

An exemplary embodiment of the invention is shown in FIGS. 1-37.

Referring to the FIGS. 1-9 and 24a-27b, an exemplary embodiment of the external of a door (80) and partition (90) assembly is shown. The partition (90) is defined by a window (92) which is shaped to extend to the ceiling of the operator's area where it is secured by a top hinge (120). The window (92) further extends and is adjacent to the windshield and dashboard of the transit vehicle such that only a small gap, if any, exits.

A floor mounting bracket (96) is secured to the floor of the transit vehicle and to the bottom of the window (92) by an isolator mount (190) which is connected to a bottom hinge (160). The floor mounting bracket (96) can be designed to fit around a fare box or may have a panel (98) which removes any access to the operator's area under the dashboard.

The floor mounting bracket (96) has a latch loop (100) which forms part of the locking mechanism, which is discussed in greater detail below.

The door (80) is defined by a window (82) which extends to the ceiling of the vehicle and is adjacent to the window (92) of the partition. The door (80) is further defined by a panel (84) which is secured to the bottom of the window (82) and extends to the floor of the transit vehicle.

The door (80) is secured by a hinge (116) to a frame (110) which is secured to the rear of the operator's area and allows the door to maneuver between an open and closed position. A ceiling mounting bracket (114) secures the frame (110) to the ceiling of the transit vehicle. A floor mounting bracket (112) secures the frame to the floor of the transit vehicle.

A lock housing (10) is mounted to the door (80) and secures the door (80) to the partition (90) by locking to the latch loop (100). The lock housing (10) includes an external release mechanism and internal release mechanism, wherein each release mechanism can independently function to unlock the door (80) from the latch loop (100).

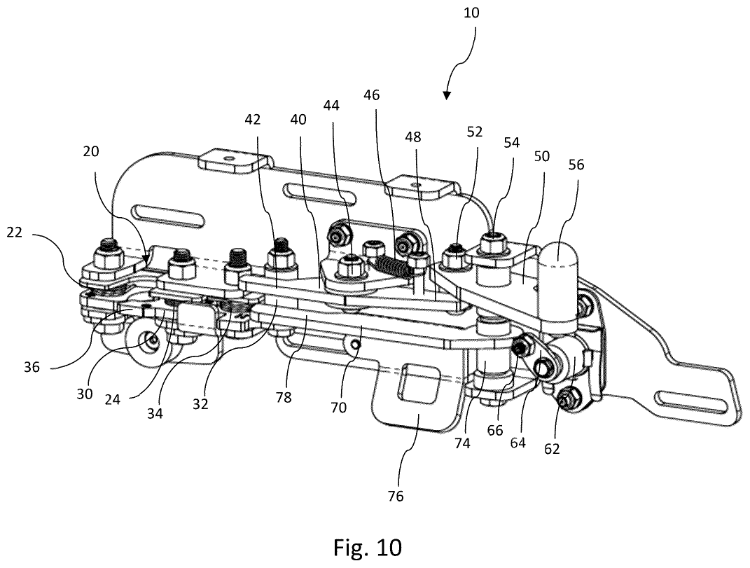

Now referring specifically to FIGS. 10-23, a locking mechanism comprising a lock housing (10) having a recess (20) which accepts a U-shaped proximal arm of the latch lever (36) and latch loop (100) positioned therein.

The recess (20) is formed between a proximal support column (22) and a distal support column (24). A space between the distal support column (24) and the lock housing (10) allows for a hooked portion (38) of the U-shaped proximal arm of the latch lever (36) to slide in and out of the space as the U-shaped proximal arm of the latch lever (36) is moved in and out of the recess (20).

The U-shaped proximal arm of the latch lever (36) rotates into the recess (20) when the latch lever (30) pivots about a central axis (34). This rotational movement is required to move the latch loop (100) out of the recess (20) and disables the door (80) from unlocking when force is applied directly to the door (80) from outside of the operator's area.

To gain access to the operator's area, the external release mechanism must be engaged. The external release mechanism has an external actuator (60) located on the external side of the door (80) as well as a handgrip access (88) where the handgrip (76) of the external release lever (70) is accessible. Ideally, the handgrip access (88) is not immediately detectable to passengers.

The external actuator (60) is connected to an internal actuator (62) which is in turn connected to a tab (64). The tab (64) is positioned such that it overlaps a distal arm of the external release lever (72). When in this position, the tab (64) prevents the distal arm of the external release lever (72) from pivoting opposite to the medial direction and thus prevents the external release mechanism from unlocking the door.

When the external actuator (60) is rotated, ideally by a specially designed key, the internal actuator (62) rotates in the same direction, as does the tab (64). The tab (64) is rotated such that it no longer overlaps with the distal arm of the external release lever (72), thus allowing the distal arm of the external release lever (72) to pivot opposite the medial direction.

With the distal arm of the external release lever (72) uninhibited by the tab (64), force can be applied to the handgrip (76) in the medial direction. This force causes the external release lever (70) to pivot about its distal axis (74), in turn causing the proximal arm of the external release lever (78) to also move in the medial direction.

As the distal arm of the external release lever (72) moves medially, it contacts and applies force to a distal column of the latch lever (32). The force applied to the distal column of the latch lever (32) causes the latch lever (30) to pivot about the central axis (34), causing the U-shaped proximal arm of the latch lever (36) to rotate out of the recess (20), allowing the latch loop (100) to be released and the unlock the door (80) from the partition (90).

To exit the operator's area, the internal release mechanism is engaged. From inside the operator's area, a handle (56) is readily accessible to the operator. The handle (56) is secured to the distal end of the first internal release lever (50). The first internal release lever (50) is pivotally moveable about a central axis (54). A column (52) is attached to the proximal arm of first internal release lever (50).

When the operator applies force to the handle (56) in the medial direction, the first internal release lever (50) pivots about the central axis (54) resulting in the column (52) on the proximal arm of the first internal release lever (50) to move opposite the medial direction.

A second internal release lever (40) has a distal arm (48) which extends to and overlaps the column (52) on the proximal arm of the first internal release lever (50) and is positioned such that the column (52) is medial to the distal arm (48).

The second internal release lever (40) is pivotally moveable about a central axis (44), such that when force is applied to the distal arm (48) by the column (52) on the proximal arm of the first internal release lever (50) opposite the medial direction, a proximal arm (42) on the second internal release lever (40) moves in the medial direction.

A biasing mechanism (46) acts between the lock housing (10) and the distal arm (48) of the second internal release lever (40), such that the distal arm (48) will remain or revert back to the medial position, unless force is applied in the opposite direction.

The biasing mechanism (46) ensures that the distal arm (48) of the second internal release lever (40) does not remain in the position opposite the medial direction such that the second internal release lever (40) may unintentionally prevent the latch lever (30) from properly securing the latch loop (100) in the recess (20).

When force is applied to the distal arm (48) opposite the medial direction, the proximal arm (42) of the second internal release lever (40) moves medially, contacting and applying force to the distal column of the latch lever (32). The force applied to the distal column of the latch lever (32) causes the latch lever (30) to pivot about the central axis (34), causing the U-Shape proximal arm of the latch lever (36) to rotate out of the recess (20), allowing the latch loop (100) to be released and the unlock the door (80) from the partition (90).

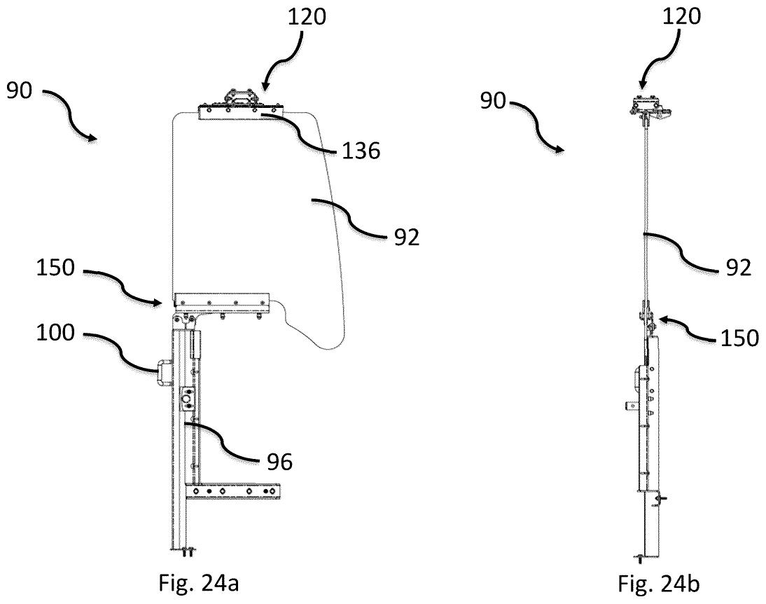

Referring now to FIGS. 24a-37, a top partition hinge (120) comprises a mounting base (128), which has a flat rectangular shaped front portion (128b) and a widened rear portion (128a). The front portion (128b) has a set of wings which extend from each side (134) which are folded upward, perpendicular to the front portion (128b) and a raised U-shape plate (146). The front portion (128b) contains at least one slot (not shown) toward that edge through which the shank of a bolt can pass through. Similarly, the widened rear portion (128a) has a plurality of holes through which the shank of a bolt can pass through.

A ceiling mount (122), which is generally U-shaped, is secured to the mounting base (128) such that the closed side of the U-shape is facing upwards. A ceiling mounting plate (130) is secured to the top of the ceiling mount (122).

At least one window mount hinge (126) is secured to the underside of the widened rear portion (128a) of the mounting base (128) by a first leaf (140). The first leaf (140) is hingeably connected to a second leaf (144). The second leaf (144) is fastened to the underside of a window mount (124). The window mount (124) is widened at the attachment to the second leaf (144) and has a rear portion (124b) that is directed toward the exterior and contains at least one slot large through for the shank of a bolt to fit through. The window mount (124) is fastened to the top of an interior window mounting plate (138). The interior window mounting plate (138) is perpendicular to the window mount (124) and comprises a channel with an opening on the bottom side (180) sized to fit the window of the partition (92). When the window of the partition (92) is in place within the channel (180) of the interior window mount (138), an exterior mounting plate (136) is secured to the exterior side of the window of the partition (92) to the interior window mount (138).

At least one locking mechanism, preferably in the form of an adjustment knob, (132) adjustably secures the front portion (124a) of the window mount (124) to the front portion (128a) of the mounting base (128). When the adjustment knob (132) is in the tightened or close position, the front portion (124a) of the window mount (124) is immovably secured to the front portion (128b) of the mounting base (128). Conversely, when the adjustment knob (132) is loosened, the window mount (124) is free to move away from the mounting base (128) through the movement of the window mount hinges (126).

A bottom partition hinge (160) comprises a partition mount (162) which secures the bottom partition hinge (160) to the interior side of the floor mounting bracket (96). A first leaf (174) is secured to the partition mount (162) and also secured to a second leaf (178) through a fulcrum (176). The second leaf (178) is secured to a bottom bracket wing (172) which is in turn secured to a mounting shelf (164). The mounting shelf (164) comprises an exterior facing lip (166) on the exterior facing side and an interior facing lip (170) on the interior facing side.

An isolator mount (190) is secured to the top of the mounting shelf (164). The isolator mount (190) comprises a shim (204), which is in direct contact with the mounting shelf (164). An elastomer layer (202) is secured to the top of the shim (204). A bottom partition window mount (200) is secured to the top of elastomer layer (202). The bottom partition window mount (200) has an exterior side lip (192). An interior clamping plate (194) is secured to the bottom partition window mount (200) such that the bottom and top of the interior clamping plate (194) is level with the exterior side lip (192), creating a channel (210) to house the partition window (92). All three sides of the channel (210) are covered by a second elastomer layer (198).

When the partition window (92) needs to transition from a closed position to an open position, the top adjustment knobs (132) and bottom adjustment knobs (206) are loosened, such that the window mount (124) of the top partition hinge (120) is free to move away from the mounting base (128) through the movement of the window mount hinge (126) and the bottom bracket (160) and isolator mount (190) are free to move interiorly via the movement of the bottom partition hinge (160).

The above description is intended in an illustrative rather than restrictive sense. Variations may be apparent to those skilled in the art without departing from the scope of the invention as defined by the claims set out below.

### PARTS LIST

| Number | Part |
|---|---|
| 10 | Lock Housing |
| 20 | Recess/Latch Socket |
| 22 | Proximal Support Column |
| 24 | Distal Support Column |
| 30 | Latch Lever |
| 32 | Distal Column of Latch Lever |
| 34 | Central Axis of Latch Lever |
| 36 | Proximal Arm of Latch Lever |
| 38 | Hooked Portion |
| 40 | Second Internal Release Lever |
| 42 | Proximal Arm of Second Internal Release Lever |
| 44 | Central Axis of Second Internal Release Lever |
| 46 | Biasing Mechanism |
| 48 | Distal Arm of Second Internal Release Lever |
| 50 | First Internal Release Lever |
| 52 | Proximal Column of First Internal Release Lever |
| 54 | Central Axis of First Internal Release Lever |
| 56 | Handle of First Internal Release Lever |
| 60 | External Actuator |
| 62 | Internal Actuator |
| 64 | Tab |
| 66 | Actuator Nut |
| 70 | External Release Lever |
| 72 | Distal Arm of External Release Lever |
| 74 | Distal Axis of External Release Lever |
| 76 | Handgrip |
| 78 | Proximal Arm of External Release Lever |
| 80 | Door |
| 82 | Window |
| 84 | Panel |
| 86 | Stopper |
| 88 | Handgrip Access |
| 90 | Partition |
| 92 | Window |
| 94 | Ceiling Mounting Bracket |
| 96 | Floor Mounting Bracket |
| 98 | Panel |
| 100 | Latch Loop |
| 110 | Frame |
| 112 | Floor Mounting Bracket |
| 114 | Ceiling Mounting Bracket |
| 116 | Hinge |
| 120 | Top Partition Hinge |
| 122 | Ceiling Mount |
| 124 | Window Mount |
| 124a | Front Portion |
| 124b | Rear Portion |
| 126 | Window Mount Hinges |
| 128 | Mounting Base |
| 130 | Ceiling Mounting Plate |
| 132 | Adjustment Knob(s) |
| 134 | Wings |
| 136 | Exterior Clamping Plate |
| 138 | Interior Window Mounting Plate |
| 140 | First Leaf |
| 142 | Top Hinge Fulcrum |
| 144 | Second Leaf |
| 146 | U-Shaped Plate |
| 148 | Elastomer |
| 160 | Bottom Partition Hinge |
| 162 | Partition Mount |
| 164 | Mounting Shelf |
| 166 | Exterior Facing Lip |
| 168 | Mounting Shelf Bracket |
| 170 | Interior Facing Lip |
| 172 | Bottom Bracket Wing |
| 174 | First Leaf |
| 176 | Fulcrum |
| 178 | Second Leaf |
| 180 | Channel |
| 190 | Isolator Mount |
| 192 | Exterior Side Lip |
| 194 | interior Clamping Plate |
| 196 | Cushion |
| 198 | Top Elastomer |
| 200 | Bottom Partition Window Mount |
| 202 | Bottom Elastomer |
| 204 | Shim |
| 206 | Adjustment Knobs |
| 208 | Isolator Cap |
| 210 | Channel |

What is claimed is:

1) A partition and a door assembly for an operator's area of a transit vehicle;
the partition having:
at least one window, wherein the window extends to a ceiling of the transit vehicle at a top edge and extends adjacent to a windshield and a dashboard of the transit vehicle;
at least one mounting bracket, the top of which is fixed to a bottom edge the window and the bottom of which is fixed to a floor of the transit vehicle; and
a latch loop;
the door having;
at least one window, wherein the window extends from a ceiling of the transit vehicle and is adjacent to the partition;
at least one panel, wherein the panel is secured to the window and extends to the floor of the transit vehicle;
at least one frame, wherein the frame is mounted to a rear wall of the operators area and extends to the ceiling of the operators area and to the floor of the operators area and hingeably attaches the rear end of the door; and
at least one lock, which secures the door to the partition via the latch loop when in a locked position, having:
an external release mechanism; and
an internal release mechanism.

2) A locking mechanism comprising:
a lock housing having a recess on an inner side for receiving a latch loop;
a latch mechanism mounted to said lock housing extending across an open end of said recess said latch mechanism being moveable between and open configuration where said latch loop may enter or leave said latch mechanism and a closed configuration trapping said latch loop in said recess;
an inner release mechanism mounted to said lock housing and accessible from the inner side of said lock housing, said inner release mechanism being connected to said latch mechanism for moving said latch mechanism between said open and closed configurations; and
an external release mechanism mounted to said lock housing and accessible from an outer side of said lock housing, opposite to said inner side, said inner release mechanism being connected to said latch mechanism for moving said latch mechanism between said open and closed configurations.

3) The locking mechanism according to claim 2, wherein;
the latch loop is secured to a partition;
the lock housing is secured to a door, such that the lock housing is aligned with the latch loop;
a latch lever secured to the lock housing, having a U-shaped proximal end such that the latch loop can be received by the proximal end of the latch lever;
the latch lever is pivotally moveable between a closed position and an open position such that when force is applied to a column attached to the distal end of the latch lever in a medial direction, the latch lever pivots about a central axis which causes the proximal end to move opposite to the medial direction from the closed position into the open position;
the proximal end of the latch lever, when opposite the medial position, enables the latch loop to move freely in or out of the U-shaped proximal arm, whereas when the proximal arm is in the medial position with the latch loop secured in the U-shaped proximal arm, the latch loop is prevented from being released.

4) The locking mechanism according to claim 3, comprising:
an internal release mechanism, having:
a second internal release lever pivotally mounted to the lock housing distal to the latch lever for pivotal movement about a central axis, wherein a proximal arm of the second internal release lever extends to the column of the latch lever such that when the proximal arm of the second internal release lever is moved in the medial direction, the proximal arm applies force to the column of the latch lever in the medial direction;
the second internal release lever is pivotally moveable about a central axis, such that when force is applied to a distal arm opposite the medial direction, the proximal arm moves in the medial direction;
a biasing mechanism acting between the lock housing and the distal arm of the second internal release lever for maintaining the distal arm of the second internal release lever in a medial position unless force is applied opposite the medial direction;
a first internal release lever pivotally mounted to the lock housing distal to the second internal release lever, an actuator rod attached to the proximal end of the first internal release lever and extends to the distal arm of the second internal release lever, such that when a handle on the distal arm of the first internal release lever is moved opposite the medial direction force is applied opposite the medial direction to the distal arm of the second internal release lever.

5) The locking mechanism according to claim 3, comprising:
an external release mechanism having:
an external release lever pivotally mounted to the lock housing distal to the latch lever, wherein a proximal arm of the external release lever extends to the column of the latch lever;
a handgrip is attached to the external release lever and positioned between the proximal arm and a distal axis, such that when force is applied to the handgrip in the medial direction, the proximal arm of the external release lever moves in the medial direction;
a distal arm on the external release lever is positioned on the distal side of the distal axis of the external release lever;
a lockout secured to the lock housing located distal to the external release lever, having:
a rotatable external portion accessible on the outside of the door;
a rotatable internal portion located on the inside of the door; and
a rotatable tab connected to the internal portion, such that the rotatable tab extends to the distal arm of the external release lever preventing the distal arm of the external release lever from pivoting opposite to the medial direction unless rotated.

6) The locking mechanism according to claim 3, comprising:
an internal release mechanism, having:
a second internal release lever pivotally mounted to the lock housing distal to the latch lever for pivotal movement about a central axis, wherein a proximal arm of the second internal release lever extends to the column of the latch lever such that when the proximal arm of the second internal release lever is moved in the medial direction, the proximal arm applies force to the column of the latch lever in the medial direction;
the second internal release lever is pivotally moveable about a central axis, such that when force is applied to a distal arm opposite the medial direction, the proximal arm moves in the medial direction;
a biasing mechanism acting between the lock housing and the distal arm of the second internal release lever for maintaining the distal arm of the second internal release lever in a medial position unless force is applied opposite the medial direction;
a first internal release lever pivotally mounted to the lock housing distal to the second internal release lever, an actuator rod attached to the proximal end of the first internal release lever and extends to the distal arm of the second internal release lever, such that when a handle on the distal arm of the first internal release lever is moved opposite the medial direction force is applied opposite the medial direction to the distal arm of the second internal release lever;
an external release mechanism having:
an external release lever pivotally mounted to the lock housing distal to the latch lever, wherein a proximal arm of the external release lever extends to the column of the latch lever;
a handgrip is attached to the external release lever and positioned between the proximal arm and a distal axis, such that when force is applied to the handgrip in the medial direction, the proximal arm of the external release lever moves in the medial direction;
a distal arm on the external release lever is positioned on the distal side of the distal axis of the external release lever;
a lockout secured to the lock housing located distal to the external release lever, having:
a rotatable external portion accessible on the outside of the door;
a rotatable internal portion located on the inside of the door; and
a rotatable tab connected to the internal portion, such that the rotatable tab extends to the distal arm of the external release lever preventing the distal arm of the external release lever from pivoting opposite to the medial direction unless rotated.

7) The partition according to claim 1, having a top partition hinge which secures the partition window to the ceiling of the transit vehicle, comprising a mounting base; at least one hinge; a window mount; a ceiling mount; an interior window mounting plate; and a locking mechanism;
such that the mounting base is hingeably secured to the window mount via the at least one hinge; the mounting base is secured to a ceiling of the transit vehicle by the ceiling mount and to the partition window by the interior window mounting plate; and the locking mechanism provides the at least one hinge to maneuver between and open and closed position.

8) The partition according to claim 7, wherein the mounting base comprises:
a front portion and a rear portion, the front portion comprises a set of wings which extend from each side and are perpendicular to the front portion; and
a u-shaped plate that is secured to the mounting base between the wings and is oriented such that the u-shape is inverted.

9) The partition according to claim 7, wherein the at least one hinge comprises a first leaf hingeably connected to a second leaf by a fulcrum, wherein the first leaf is secured to the underside of the mounting plate and the second leaf is secured to the underside of the window mount, such that the window mount can hingeably move to or from the mounting plate.

10) The partition mount according to claim 7, wherein the ceiling mount is secured to the wings of the mounting base and to a ceiling mounting plate, said ceiling mounting plate is secured to the ceiling of the transit vehicle.

11) The partition according to claim 7, wherein the interior window mounting plate is secured to the underside of the window mount and is generally perpendicular to said mounting plate, and comprises an exterior clamping plate is secured to the interior window mounting plate, such that a channel is created between a bottom portion of said window mounting plate and said exterior mounting plate; and an elastomer layer is adhered within the channel, making said channel sized to fit the partition window.

12) The partition according to claim 7, wherein the locking mechanism is an adjustment knob.

13) The partition according to claim 12, where the adjustment knob secures the window mount to the mounting base at the rear portion, such that when the adjustment knob is tightened, the window mount is secured to the mounting base, and when the adjustment knob is loosened, the window mount can move away from the mounting base.

14) The partition according to claim 1, having:
a bottom partition hinge which secures the bottom of the partition window to the floor mounting bracket, comprising a partition mount; at least one hinge; a mounting shelf bracket; a locking mechanism; and an isolator mount;
such that the partition mount that is secured to the partition and connected to one end of the at least one hinge; the at least one hinge is further connected to the mounting shelf bracket at the other end; the isolator mount is secured to the mounting shelf bracket and fitted to receive the bottom of the partition window, allowing the partition window to hingeably move to and from the floor mounting bracket.

15) The partition according to claim 14, wherein the at least one hinge comprises:
a first leaf is secured to the partition mount and connected to a second leaf through a fulcrum;
the second leaf is secured to a bottom bracket wing of a mounting shelf bracket, such that the partition window is hingeably moveable to and from the floor mounting bracket.

16) The partition according to claim 14, wherein the isolator mount comprises:
a shim secured to the top of the mounting shelf;
a bottom elastomer layer secured to the top of the shim;
a bottom partition window mount secured to the top of the bottom elastomer layer;
an exterior side lip extending from the bottom partition mount;
an interior side lip that is secured to the bottom partition mount such that a channel is formed between said interior side lip and said exterior side lip;
a top elastomer layer lining the inside of the channel, such that the partition window can fit in said channel.

17) The partition according to claim 14, wherein the locking mechanism is an adjustment knob.

18) The partition according to claim 12, where the adjustment knob secures the partition mount to the mounting shelf bracket, such that when the adjustment knob is tightened, the mounting shelf bracket is secured to the partition mount, and when the adjustment knob is loosened, the window mount can move away from the partition mount.
